(19) United States
(12) Patent Application Publication
(10) Pub. No.: US 2017/0323252 A1
(43) Pub. Date: Nov. 9, 2017

(54) RF PERMEABILITY MEASURE OF PRODUCT OUT OF STOCKS

(71) Applicant: Wal-Mart Stores, Inc., Bentonville, AR (US)

(72) Inventors: Nicholaus A. Jones, Fayetteville, AR (US); Matthew A. Jones, Bentonville, AR (US)

(21) Appl. No.: 15/585,359

(22) Filed: May 3, 2017

Related U.S. Application Data
(60) Provisional application No. 62/332,053, filed on May 5, 2016.

(51) Int. Cl. G06Q 10/08; G01S 13/88

(52) U.S. Cl. CPC G06Q 10/087; G01S 13/88

(57) ABSTRACT

Apparatuses, systems, and methods are provided herein useful to determining qualities associated with products presented for sale in a shopping facility. In some embodiments, the system includes a transmitter located on a first side of a group of products, wherein the transmitter is configured to emit energy toward and through the group of products. The system can also include a receiver located on a second side of the group of products, wherein the receiver is configured to receive a transmitted portion of the energy emitted toward and through the group of products, wherein the transmitted portion of the energy emitted toward and through the group of products is used to estimate a stock level of a product display.

### RELATED APPLICATION

This application claims the benefit of U.S. Provisional Application No. 62/332,053, filed May 5, 2016, which is incorporated herein by reference in its entirety.

### TECHNICAL FIELD

This invention relates generally to products presented for sale in a shopping facility and, more particularly, to determining qualities of the products presented for sale in a shopping facility.

### BACKGROUND

Guests of a shopping facility may become frustrated when they are unable to locate products that they would like to purchase. Oftentimes, guests cannot find the products they would like to purchase because products are not properly stocked (e.g., the product display unit on which the product should be located is empty) or located within the shopping facility (e.g., the product on a product display unit is not the correct product). Guest satisfaction is improved when products presented for sale in the shopping facility are properly stocked and located. Additionally, the number of products that each guest purchases may increase when products are properly stocked and located. Consequently, there exists a need for systems and methods that ensure that products presented for sale in a shopping facility are properly stocked and located.

### BRIEF DESCRIPTION OF THE DRAWINGS

Disclosed herein are embodiments of systems, apparatuses and methods useful for determining qualities of products presented for sale in a shopping facility. This description includes drawings, wherein:

FIG. 1 depicts a product display unit 100 including transmitters 104 and receivers 102, according to some embodiments.

FIG. 2 is a side view of a first shelf 212 and a second shelf 224 of a product display unit, wherein the first shelf includes a first receiver 202 and the second shelf includes a second receiver 214, according to some embodiments.

FIG. 3 is a flow chart depicting example operations for estimating a stock level of a product presented for sale on a product display unit, according to some embodiments.

FIG. 4 is a side view of a shelf 420 of a product display unit 402 including a receiver 408 and a transmitter 418, according to some embodiments.

FIG. 5 is a flow chart depicting example operations for determining a type of product presented for sale on a product display unit, according to some embodiments.

FIG. 6 is a flow chart depicting example operations for using a transmitted portion of energy emitted toward a group of products and a reflected portion of energy emitted toward the group of products to estimate a stock level and type of product presented for sale on a product display unit, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to determining qualities associated with products presented for sale in a shopping facility. In some embodiments, a system comprises a transmitter located on a first side of a group of products, wherein the transmitter is configured to emit energy toward and through the group of products. The system can also comprise a receiver located on a second side of the group of products, wherein the receiver is configured to receive a transmitted portion of the energy emitted toward and through the group of products, wherein the transmitted portion of the energy emitted toward and through the group of products is used to estimate a stock level of a product display.

Shopping facilities strive to maintain proper stocking and placement of products presented for sale on product display units within the shopping facility. Ensuring that all products presented for sale in the shopping facility are properly stocked and located is a labor intensive and time consuming task. Additionally, this task must be performed repeatedly to ensure that the products presented for sale remain properly stocked and located. Embodiments of the inventive subject matter include systems, apparatuses, and methods that aid a shopping facility in ensuring that products are properly stocked and located on product display units within the shopping facility. Some embodiments of the inventive subject matter include emitters and receivers. The emitters emit energy toward and through products presented for sale on a product display. The receivers receive the energy emitted by the transmitters. The magnitude of the energy transmitted decreases as it passes through the products. A number of products, and in some embodiments a type of the products, can be determined based on the transmitted energy.

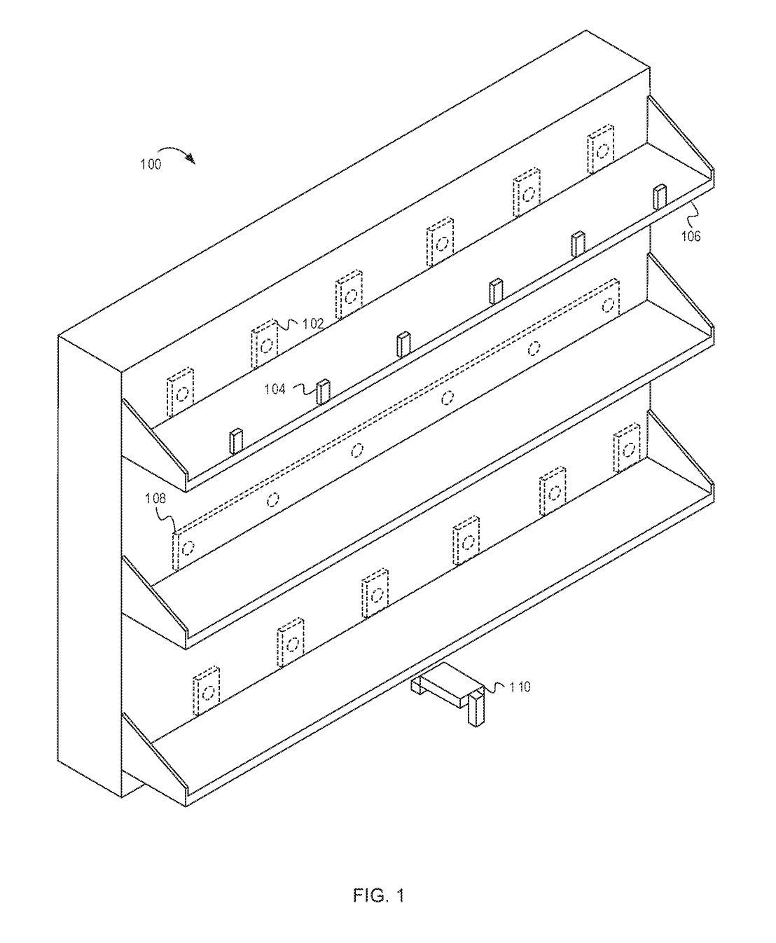

FIG. 1 depicts a product display unit 100 including transmitters 104 and receivers 102, according to some embodiments. The transmitters 104 and the receivers 102 are affixed to the product display unit 100. In some embodiments, each row of products on the product display unit 100 has an associated receiver (i.e., receivers 102). In other embodiments, a section of the product display unit (e.g., a shelf, a portion of a shelf, etc.) has a single receiver (e.g., receiver 108). The transmitters 104 emit energy (e.g., radiofrequency (RF) waves) and the receivers 102 receive the emitted energy. In addition to, or in lieu of, the transmitters 104 that are affixed to the product display unit 100, embodiments of the inventive subject matter include portable transmitters 110 (e.g., a transmitter 110 located on a mobile device). The portable transmitter 110 can be operated by a person (e.g., handheld, attached to a movable device, etc.) or automated (e.g., a robotic mechanism that moves through the aisles). In some embodiments, the transmitters 104 and 110 can also act as receivers (i.e., transceivers). In such embodiments, the transmitters 104 and 110 can receive a reflected portion of the energy emitted. Based on the reflected portion of the energy emitted, the system can determine a type of product that is presented on the product display unit 100.

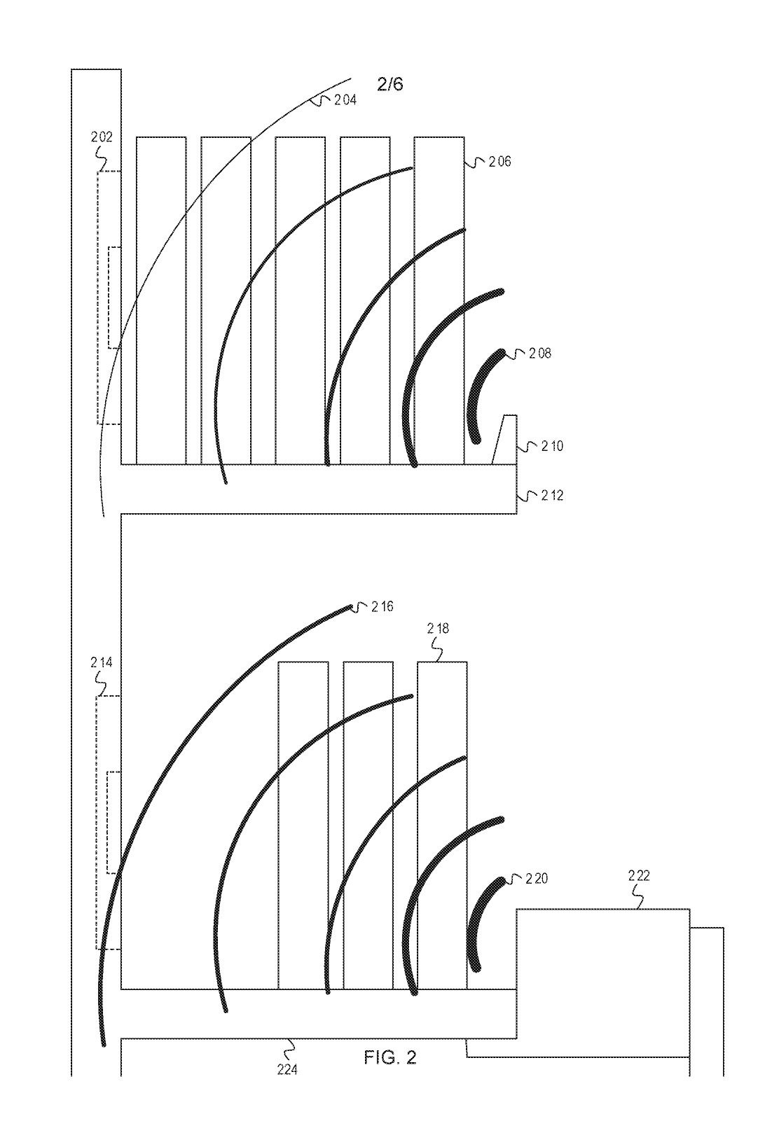

While FIG. 1 provides an overview of an example system for using energy transmission to determine stock levels in a shopping facility, FIG. 2 and the associated text provide greater details of the system.

FIG. 2 is a side view of a first shelf 212 and a second shelf 224 of a product display unit, wherein the first shelf includes a first receiver 202 and the second shelf includes a second receiver 214, according to some embodiments. The first receiver 202 and the second receiver 214 are depicted as being housed within the product display unit (as indicated by the hashed lines). The first receiver 202 is affixed to the first shelf 212. The first transmitter emits energy toward and through products 206 presented for sale on the first shelf 212. As the energy traverses through the products 206, the magnitude of the energy decreases. The magnitude of the energy decreases as it traverses through the products 206 because the products absorb and/or reflect a portion of the emitted energy. This decrease in the magnitude of the energy is depicted by the decreasing thickness of the lines representing the energy emission. For example, the line 208 just leaving the first transmitter 210 is thicker than the line 204 representing the transmitted energy after it has passed through a number of the products 206. Put simply, the magnitude of the emitted energy is inversely proportional to the number of products 206 through which the emitted energy has passed. The first receiver 202 receives the portion of the emitted energy, the portion being the amount of energy that has passed through the products 206.

A portable transmitter 222 emits energy toward products 218 presented for sale on the second shelf 224. The portable transmitter 222 can be handheld or part of a larger device (e.g., an automated system). In an automated system, the portable transmitter 222 can be affixed to a robotic device. The robotic device can travel through the shopping facility on a predetermined path. For example, using a coordinate system or location determination, the robotic device can follow the predetermined path. The portable transmitter 222 can be configured to rest on or near the second shelf 224 at a predetermined distance (as depicted in FIG. 2). Such a design is beneficial because the portion of the energy emitted is dependent on the distance between the portable transmitter 222 and the products 218 and/or second receiver 214. The energy emitted by the portable transmitter 222 traverses through the products 218. The second receiver 214 receives the emitted energy. As the energy traverses through the products 218 its magnitude decreases. The energy's magnitude decreases because the products 218 absorb and/or reflect a portion of the energy. As depicted in FIG. 2, the line 220 is thicker than the line 216, representing this decrease in magnitude. The products 218 on the second shelf include only three products, whereas the products 206 on the first shelf 212 include five products. Assuming the products 218 on the second shelf 224 are the same as the products 206 on the first shelf 212, the energy absorption and/or reflection should be the same per product for the products 218 on the second shelf 224 and the products 206 on the first shelf 212. Consequently, a greater portion of the emitted energy will be absorbed and/or reflected by the products 206 on the first shelf 212 than the products 218 on the second shelf 224. This is depicted in FIG. 2 as the line 216 (representing the energy emitted through the products 218 on the second shelf 224) is thicker than the line 204 (representing the energy emitted through the products 206 on the first shelf 212).

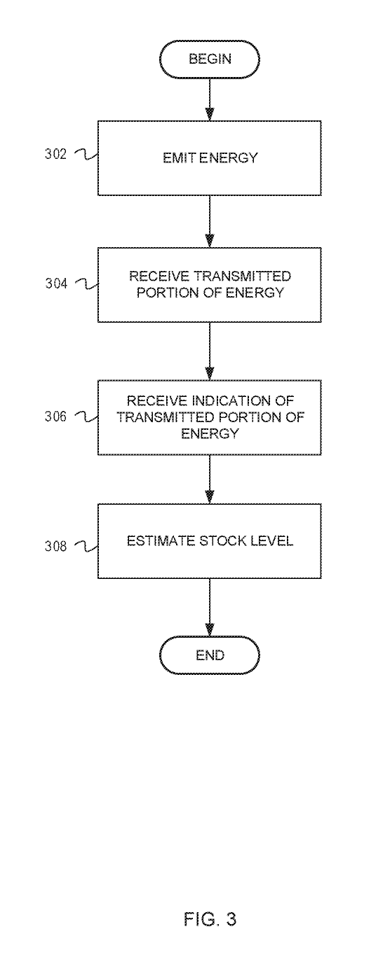

While FIG. 2 and the related text describe energy being transmitted through a group of products, FIG. 3 is a flow chart including example operations for receiving energy transmitted through products on a product display unit.

FIG. 3 is a flow chart depicting example operations for estimating a stock level of a product presented for sale on a product display unit, according to some embodiments. The flow begins at block 302.

At block 302, energy is emitted toward and through a group of products. For example, a transmitter emits the energy toward and through the group of products. The transmitter can be located (whether permanent or movable) at a first side of the group of products. The energy (e.g., electromagnetic waves) can be emitted in any suitable wavelength. In some embodiments, the magnitude of the energy and the wave length of the energy is based on the products toward and through which the energy is intended to be transmitted. Additionally, the magnitude and wavelength of the emitted energy can be varied based on environmental conditions. For example, the magnitude and wavelength of the emitted energy can be varied based on temperature, humidity, atmospheric pressure, elevation, etc., as the conditions may affect the transmission and/or absorption of the energy. The flow continues at block 304.

At block 304, a transmitted portion of the emitted energy is received. For example, a receiver can receive the transmitted portion of the emitted energy. The receiver can be located at a second side of the group of products opposite the first side. Because the energy is transmitted through the group of products, the group of products may absorb and/or reflect some of the emitted energy. The energy received by the receiver is the portion of the energy that was neither absorbed nor reflected by the group of products. The flow continues at block 306.

At block 306, an indication of the transmitted portion of the energy is received. For example, a control circuit can receive the indication of the transmitted portion of the energy. The indication of the transmitted portion of the energy can indicate the magnitude of the transmitted portion of the energy, as well as other properties associated with the transmitted portion of the energy or the environmental conditions. For example, the indication of the transmitted portion of the energy can include a current temperature, humidity, atmospheric pressure, elevation, etc. The flow continues at block 308.

At block 308, a stock level is estimated. For example, the control circuit estimates the stock level. The stock level is estimated based on the indication of the transmitted portion of the energy. The stock level is the level (e.g., number) of products presented for sale on the product display unit. Because the energy is absorbed and/or reflected by the group of products, the portion of the energy transmitted relative to the energy emitted is indicative of the stock level. For example, the greater the number of products in the group of products, the lesser the portion of the energy transmitted (i.e., the greater the amount of the energy emitted that is absorbed and/or reflected by the group of products). In some embodiments, the stock level is estimated based on a predetermined energy level (e.g., based on experimental or observed data). For example, a relationship between type of product, location of product on the product display unit, and number of products on the product display unit and portion of the energy transmitted can be determined. As a baseline value, the transmitter can emit the energy toward the receiver when no products are located on the product display unit. This can be repeated for one or more other conditions (e.g., with differing numbers of products on the product display unit) to obtain a greater number of data points. The relationship between the products on the product display unit and the portion of the energy transmitted can be determined based on these data points (e.g., by plotting a curve). Additionally, a similar process can be used to determine a relationship between environmental conditions and the portion of the energy transmitted. The control circuit determines the stock level based on these relationships.

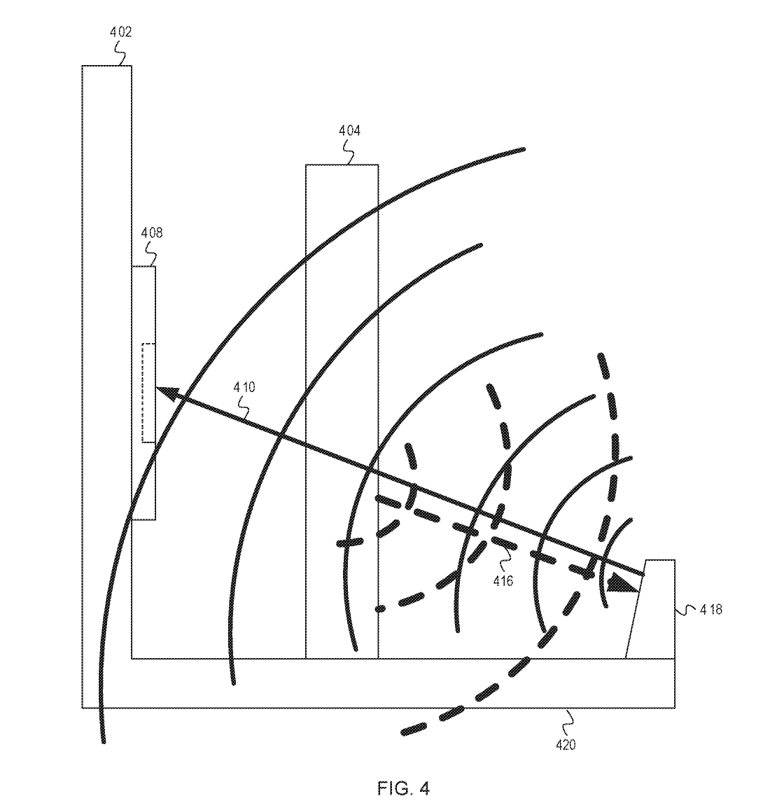

While FIG. 3 is a flow chart depicting example operations for receiving energy transmitted through products on a product display unit, FIG. 4 and the related text describe energy being reflected by a group of products.

FIG. 4 is a side view of a shelf 420 of a product display unit 402 including a receiver 408 and a transmitter 418, according to some embodiments. The transmitter 418 emits energy toward and through a product 404 presented for sale on the shelf 420. The emitted energy is received by the receiver 408, as indicated by a transmission arrow 410. In the embodiment depicted in FIG. 4, the receiver 408 is affixed to an outer portion of the product display unit 402. A portion of the emitted energy is absorbed by the product 404 before the energy reaches the receiver 408. In addition to emitting energy, the transmitter 418 receives energy reflected by the product 404, as indicted by a reflection arrow 416. As the transmitter 418 emits energy, the product 404 reflects a portion of the energy back toward the transmitter 418. Properties of the reflected energy (e.g., a magnitude, wavelength, reflection delay, etc.) are indicative of properties associated with the product 404.

In some embodiments the system can determine how many products 404 are on the shelf 420 based on these properties. For example, the delay between the emission of the energy and the reception of the reflected portion of the energy is indicative of how far the product 404 is from the transmitter 418. If the distance indicates that the product 404 is at the rear of the shelf 420, it may indicate that the product is not properly zoned on the shelf or that an insufficient number of the product 404 is on the shelf.

In some embodiments, the system can determine a type of the product 404 based on the properties of the reflected energy. The system can determine the type of the product 404 because different products have different reflectivity properties. For example, metallic packaging, such as soup cans, may reflect more energy than nonmetallic packaging. Additionally, different types of nonmetallic packaging may have different reflectivity properties (e.g., clothes versus cardboard boxes), or the reflectivity of a product may vary based on the product inside the packaging (e.g., a cardboard box containing pasta compared to a cardboard box containing a plastic object). Determining a type of product based on the reflected energy can be useful in determining that products are incorrectly located on the product display unit 402. For example, if the product 404 exhibits high reflectivity properties but the product display unit 402 is supposed to present boxes of cereal for sale, the product 404 may be the wrong product (i.e., a product other than a box of cereal).

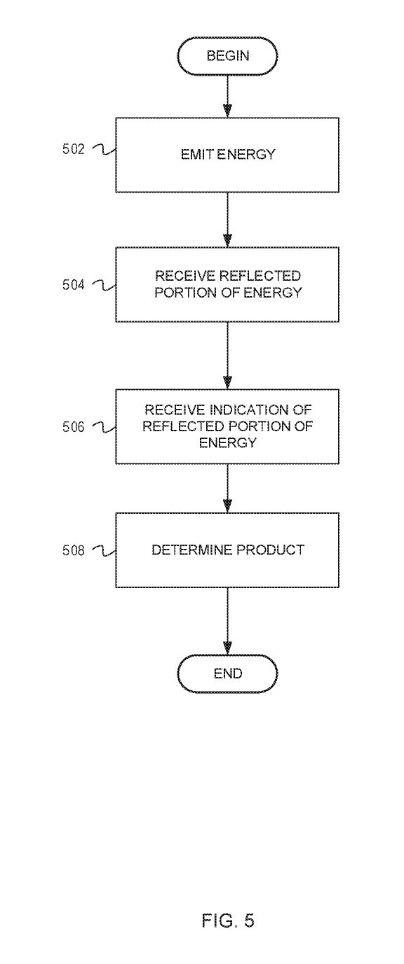

While FIG. 4 and the related text describe a system for detecting energy reflected by products on a product display unit, FIG. 5 is a flow chart including example operations for receiving energy reflected by products on a product display unit.

FIG. 5 is a flow chart depicting example operations for determining a type of product presented for sale on a product display unit, according to some embodiments. The flow begins at block 502.

At block 502, energy is emitted toward a group of products. For example, a transmitter emits the energy toward the group of products. The energy (e.g., electromagnetic waves) can be emitted in any suitable wavelength. In some embodiments, the magnitude of the energy and the wave length of the energy are based on the products toward which the energy is intended to be emitted. Additionally, the magnitude and wavelength of the emitted energy can be varied based on environmental conditions. For example, the magnitude and wavelength of the emitted energy can be varied based on temperature, humidity, atmospheric pressure, elevation, etc., as the conditions may affect the emission and/or reflection of the energy. The flow continues at block 504.

At block 504, a reflected portion of the emitted energy is received. For example, a receiver can receive the reflected portion of the emitted energy. Some embodiments of the inventive subject matter utilize a dedicated receiver to receive the reflected portion of the emitted energy. In other embodiments, the transmitter, acting as a transceiver, receives the reflected portion of the emitted energy. Because the energy is reflected by the group of products, the group of products may absorb and/or disperse some of the emitted energy. The energy received by the receiver is the portion of the energy that was neither absorbed nor dispersed by the group of products. The flow continues at block 506.

At block 506, an indication of the reflected portion of the energy is received. For example, a control circuit can receive the indication of the reflected portion of the energy. The indication of the reflected portion of the energy can indicate the magnitude of the reflected portion of the energy, as well as other properties associated with the reflected portion of the energy or environmental conditions. For example, the indication of the reflected portion of the energy can include a current temperature, humidity, atmospheric pressure, elevation, etc. The flow continues at block 508.

At block 508, a product is determined. For example the control circuit determines the type of product on the product display unit. The product is determined based on the indication of the reflected portion of the energy. Because the energy is absorbed and/or dispersed by the group of products, the portion of the energy reflected relative to the energy emitted is indicative of the type of product reflecting the energy. For example, metallic objects may reflect more energy than nonmetallic objects. The determination of the product can be based on experimental or observed data. For example, a relationship between type of product, location of product on the product display unit, and number of products on the product display unit and portion of the energy reflected can be determined. Additionally, a relationship can be determined between environmental conditions and the portion of the energy reflected. The control circuit determines the product based on these relationships. In some embodiments, the control circuit can determine that an incorrect product is located on the product display unit. For example, after identifying the product, the control circuit can determine the correct product for the product display unit, for example, by referencing a planogram. The control circuit can compare the product to the correct product to determine that the product is incorrectly located.

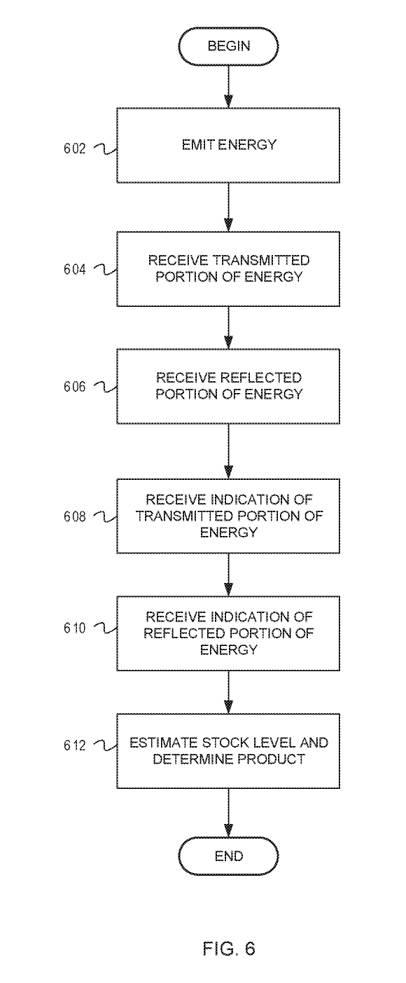

While FIG. 3 is a flow chart depicting example operations for receiving energy transmitted through a group of products and FIG. 5 is a flow chart depicting example operations for receiving energy reflected by a group of products, FIG. 6 is a flow chart depicting example operations for receiving energy both transmitted through, and reflected by, a group of products.

FIG. 6 is a flow chart depicting example operations for using a transmitted portion of energy emitted toward a group of products and a reflected portion of energy emitted toward the group of products to estimate a stock level and type of product presented for sale on a product display unit, according to some embodiments. The flow begins at block 602.

At block 602, energy is emitted toward and through a group of products. For example, a transmitter emits the energy toward and through the group of products. The transmitter can be located (whether permanent or movable) at a first side of the group of products. The energy (e.g., electromagnetic waves) can be emitted in any suitable wavelength. In some embodiments, the magnitude of the energy and the wave length of the energy are based on the products toward and through which the energy is intended to be emitted. Additionally, the magnitude and wavelength of the emitted energy can be varied based on environmental conditions. For example, the magnitude and wavelength of the emitted energy can be varied based on temperature, humidity, atmospheric pressure, elevation, etc., as the conditions may affect the transmission and/or absorption of the energy. The flow continues at block 604.

At block 604, a transmitted portion of the emitted energy is received. For example, a receiver can receive the transmitted portion of the emitted energy. The receiver can be located at a second side of the group of products opposite the first side. Because the energy is transmitted through the group of products, the group of products may absorb and/or reflect some of the emitted energy. The energy received by the receiver is the portion of the energy that was neither absorbed nor reflected by the group of products. The flow continues at block 606.

At block 606, a reflected portion of the emitted energy is received. For example, a receiver can receive the reflected portion of the emitted energy. Some embodiments of the inventive subject matter utilize a dedicated receiver to receive the reflected portion of the emitted energy. In other embodiments, the transmitter, acting as a transceiver, receives the reflected portion of the emitted energy. Because the energy is reflected by the group of products, the group of products may absorb and/or disperse some of the emitted energy. The energy received by the receiver is the portion of the energy that was neither absorbed nor dispersed by the group of products. The flow continues at block 608.

At block 608, an indication of the transmitted portion of the energy is received. For example, a control circuit can receive the indication of the transmitted portion of the energy. The indication of the transmitted portion of the energy can indicate the magnitude of the transmitted portion of the energy, as well as other properties associated with the transmitted portion of the energy or the environmental conditions. For example, the indication of the transmitted portion of the energy can include a current temperature, humidity, atmospheric pressure, elevation, etc. The flow continues at block 610.

At block 610, an indication of the reflected portion of the energy is received. For example, a control circuit can receive the indication of the reflected portion of the energy. The indication of the reflected portion of the energy can indicate the magnitude of the reflected portion of the energy, as well as other properties associated with the reflected portion of the energy or environmental conditions. For example, the indication of the reflected portion of the energy can include a current temperature, humidity, atmospheric pressure, elevation, etc. The flow continues at block 612.

At block 612, a stock level is estimated and a product is determined. For example, the control circuit estimates the stock level and determines the product. The control circuit can estimate the stock level based on the indication of the transmitted portion of the energy and/or the indication of the reflected portion of the energy. Additionally, the control circuit can estimate the product based on the indication of the transmitted portion of the energy and/or the indication of the reflected portion of the energy. In some embodiments, using both the indication of the transmitted portion of the energy and the indication of the reflected portion of the energy to estimate the stock level and/or determine the product is more accurate than using only the indication of the transmitted portion of the energy or the indication of the reflected portion of the energy. Additionally, when estimating the stock level, the control circuit can account for the current temperature, humidity, atmospheric pressure, elevation, time, etc.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, although this specification refers to determine stock level and product type for products presented for sale in a shopping facility, embodiments are not so limited. Some embodiments of the inventive subject matter can be used in environments other than a sales floor of a shopping facility. For example, embodiments of the inventive subject matter can be used in a stock room, a shipping facility, a warehouse, or any other locations where determining a number of items or type of items can be useful.

In some embodiments, a system comprises a transmitter located on a first side of a group of products, wherein the transmitter is configured to emit energy toward and through the group of products, and a receiver located on a second side of the group of products, wherein the receiver is configured to receive a transmitted portion of the energy emitted toward and through the group of products, wherein the transmitted portion of the energy transmitted toward and through the group of products is used to estimate a stock level of a product display.

In some embodiments, a method comprises emitting, via a transmitter on a first side of a group of products, energy toward and through the group of products, and receiving, via a receiver on a second side of the group of products, a transmitted portion of the energy, wherein the transmitted portion of the energy is used to estimate a stock level of a product display.

In some embodiments, a system comprises a transmitter located on a first side of a group of products, wherein the transmitter is configured to emit energy toward and through the group of products, a receiver located on a second side of the group of products, wherein the receiver is configured to receive a transmitted portion of the energy emitted toward and through the group of products, and a control circuit configured to receive, from the receiver, an indication of the transmitted portion of the energy emitted toward and through the group of products, and estimate a stock level for a product on the product display based, at least in part, on the indication of the transmitted portion of the energy.

What is claimed is:

1. A system comprising:
a transmitter located on a first side of a group of products, wherein the transmitter is configured to emit energy toward and through the group of products; and
a receiver located on a second side of the group of products, wherein the receiver is configured to receive a transmitted portion of the energy emitted toward and through the group of products, wherein the transmitted portion of the energy emitted toward and through the group of products is used to estimate a stock level of a product display.

2. The system of claim 1, wherein the transmitter is further configured to receive a reflected portion of the energy emitted toward and through the group of products.

3. The system of claim 2, further comprising:
a control circuit, wherein the control circuit is configured to receive an indication of the reflected portion of the energy emitted toward and through the group of products and determine, based at least in part, on the indication of the reflected portion of the energy emitted toward and through the group of products, that an incorrect product is located on the product display.

4. The system of claim 1, further comprising:
a control circuit, wherein the control circuit is configured to receive an indication of the transmitted portion of the energy emitted toward and through the group of products and estimate, based at least in part, on the indication of the transmitted portion of the energy emitted toward and through the group of products, the stock level of the product display.

5. The system of claim 4, wherein the control circuit is further configured to compare the transmitted portion of the energy emitted toward and through the group of products and a predetermined energy level to estimate the stock level of the product display.

6. The system of claim 4, wherein the control circuit is further configured to account for one or more of temperature, humidity, atmospheric pressure, time, and elevation to estimate the stock level of the product display.

7. The system of claim 4, wherein the control circuit is further configured to determine, based at least in part on the indication of the transmitted portion of the energy emitted toward and the through the group of products, that an incorrect product is located on the product display.

8. The system of claim 1, wherein the transmitter is located on a mobile device and the receiver is located on the product display.

9. A method comprising:
emitting, via a transmitter on a first side of a group of products, energy toward and through the group of products; and
receiving, via a receiver on a second side of the group of products, a transmitted portion of the energy, wherein the transmitted portion of the energy is used to estimate a stock level of a product display.

10. The method of claim 9, further comprising:
receiving, at the first side of the group of products a reflected portion of the energy.

11. The method of claim 10, further comprising:
determining, via a control circuit, that an incorrect product is located on the product display based, at least in part, on the reflected portion of the energy.

12. The method of claim 10, further comprising:
estimating, based at least in part on the transmitted portion of the energy, the stock level of the product display.

13. The method of claim 12, wherein the estimating the stock level of the product display includes comparing the transmitted portion of the energy with predetermined energy level.

14. The method of claim 12, wherein the estimating the stock level of the product display is based on one or more of temperature, humidity, atmospheric pressure, time, and elevation.

15. The method of claim 9, further comprising:
determining that an incorrect product is located on the product display based, at least in part, on the transmitted portion of the energy.

16. The method of claim 9, wherein the transmitter is located on a mobile device and the receiver is located on the product display.

17. A system comprising:
a transmitter located on a first side of a group of products, wherein the transmitter is configured to emit energy toward and the through the group of products;
a receiver located on a second side of the group of products, wherein the receiver is configured to receive a transmitted portion of the energy emitted toward and through the group of products; and
a control circuit, the control circuit configured to;
receive, from the receiver, an indication of the transmitted portion of the energy emitted toward and through the group of products; and
estimate a stock level for a product for the group of products based, at least in part, on the indication of the transmitted portion of the energy.

18. The system of claim 17, wherein the transmitter is further configured to receive a reflected portion of the energy emitted toward and through the group of products.

19. The system of claim 18, wherein the control circuit is further configured to determine that an incorrect product is located on the products display based, at least in part, on the reflected portion of the energy emitted toward and through the group of products.

20. The system of claim 17, wherein the control circuit is further configured to compare the transmitted portion of the energy emitted toward and through the group of products and a predetermined energy level to estimate the stock level of the product display.
